(19) United States
(12) Patent Application Publication
(10) Pub. No.: US 2005/0036559 A1
(43) Pub. Date: Feb. 17, 2005

(54) Signal processing method and corresponding encoding method and device

(76) Inventors: Catherine Lamy, Paris (FR); Slim Chabbouh, Paris (FR)

Correspondence Address: Corporate Patent Counsel;Philips Electronics North America Corporation, P O Box 3001, Briarcliff Manor, NY, 10510, US

(21) Appl. No.: 10/496,484

(22) PCT Filed: Nov. 14, 2002
(86) PCT No.: PCT/IB02/04778

(30) Foreign Application Priority Data
Nov. 27, 2001 (EP) 01403034.0

(51) Int. Cl. H04B 14/04

(52) U.S. Cl. 375/253

(57) ABSTRACT

The invention relates to a method of defining a new set of codewords for use in a variable length coding algorithm, and to a data encoding method using such a code. Said coding method comprises at least the steps of applying to said data a transform and coding the obtained coefficients by means of the variable length coding algorithm. The code used in said algorithm is built with the same length distribution as the binary Huffman code distribution, and is constructed by implementation of specific steps: (a) creating a synchronization tree structure of the codes with decreasing depths for each elementary branch of said tree, with initialized parameters D=lₘₐₓ, K=nₗₘₐₓ/2, and current l=l_{cur}=lₘₐₓ, (D and K being integers representing respectively the maximum length of a string of zeros and the maximum length of a string of ones, lₘₐₓ the greatest codeword length, and nₗₘₐₓ the number of codewords of length lₘₐₓ in the Huffman code); (b) for each length l_{cur} beginning from lₘₐₓ, if n′_{lcur}≠n_{lcur}, using the codeword lₖ as prefix and anchor to it the maximal size elementary branch of depth D′=l_{cur}−K; (c) if lₖ cannot be used as prefix, find a suitable prefix by choosing the minimal length codeword that is in excess with respect to the desired distribution.

### FIELD OF THE INVENTION

The present invention generally relates to the field of data compression and, more specifically, to a method of processing digital signal for reducing the amount of data used to represent them.

The invention also relates to a method of encoding digital signals that incorporates said signal processing method, and to a corresponding encoding device.

### BACKGROUND OF THE INVENTION

Variable length codes, such as described for example in the document U.S. Pat. No. 4,316,222, are used in many fields like video coding, in order to digitally encode symbols which have unequal probabilities to occur: words with high probabilities are assigned short binary codewords, while those with low probabilities are assigned long codewords. These codes however suffer from the drawback of being very susceptible to errors such as inversions, deletions, insertions, etc . . . , with a resulting loss of synchronization (itself resulting in an error state) which leads to extended errors in the decoded bitstream. Many words are indeed possibly decoded incorrectly as transmission continues.

How quickly a decoder may recover synchronization from an error state is the error span, i.e. the average number of symbols decoded until re-synchronization:

$${E}_{s} = {\sum }_{k = I} {P}_{{C}_{k}}^{err} \times {N}_{k} \qquad ( 1 )$$

where I is the set of the codeword indexes, P^{err}_{C}_{ₖ} is the probability of the erroneous symbol to be Cₖ, and Nₖ is the average number of symbols to be decoded until synchronization when the corrupted symbol is Cₖ. For a code well matched to the source statistics, the probability of a codeword Cₖ can be approximated by P_{C}_{ₖ}=2^{-l}ₖ, where lₖ is the length of Cₖ, and the probability of the erroneous symbol to be Cₖ can be approximated by P^{err}_{C}_{ₖ}=2^{-l}ₖ×(lₖ/l), where l is the average length of the code. The expression of Eₛ then becomes:

$${E}_{s} = {\sum }_{k ∈ I} {2}^{- {ℓ}_{k}} \times \frac{{ℓ}_{k}}{ℓ} \times {N}_{k} \qquad ( 2 )$$

According to said expression, the most probable symbols have a greater impact on Eₛ, and their contribution will therefore be minimized. For this purpose, the following family F of variable length codes is defined (expression (3)):

$$F \{ \begin{matrix}\{ \begin{matrix}{1}_{i} & {0}_{j} & 1\end{matrix} \} & for i ∈ [ 0 , K - 1 ] and j ∈ [ 1 , D - 1 ] \\ \{ \begin{matrix}{1}_{i} & {0}_{D}\end{matrix} \} & for i ∈ [ 0 , K - 1 ] \\ {1}_{k} & \end{matrix} \qquad ( 3 )$$

where 1ᵢ and 0ᵢ represent i-length strings of ones and zeros and D and K are arbitrary integers with K≦D (an example of tree structure for such a fast synchronizing code with( D, K)=(4, 3) is given in FIG. 1, in which the black circles correspond to codewords and the white circles to error states). Assuming that D and K are large enough, the most probable (MP) codewords, i.e. the shortest ones, belong to the subset C_{MP} of the family F:

$${C}_{MP} = {\{ \begin{matrix}{1}_{i} & {0}_{j} & 1\end{matrix} \}}_{i ∈ [ 0 , k - 1 ] j ∈ [ 1 , D - 1 ]} \qquad ( 4 )$$

On these codewords, several types of error positions are possible (transformation of the original codeword into one valid codeword, into the concatenation of two valide codewords, into an error state, or into the concatenation of a valid codeword and an error state). Considering that the recovery from an error state ESₖ resulting from an erroneous codeword Cₖ also depends on the codeword Cₕ following the error state, it can then be shown that, for any error state such as (lₖ+lₕ<D and Cₕ≠1ₖ), the resulting approximate error span Eₛ is bounded (assuming that D and K are large enough), and that the synchronization is always recovered after decoding Cₕ.

However, in spite of this recovery performance, such a structure is far from optimal average length and moreover does not reach every possible compression, and hence it cannot be applied to any given source.

### SUMMARY OF THE INVENTION

It is therefore an object of the invention to propose a processing method in which the operation of defining a set of codewords avoids these limitations.

To this end, the invention relates to a method of processing digital signals for reducing the amount of data used to represent said digital signals and forming by means of a variable length coding step a set of codewords such that the more frequently occurring values of digital signals are represented by shorter code lengths and the less frequently occurring values by longer code lengths, said variable length coding step including a defining sub-step for generating said set of codewords and in which the code used is built with the same length distribution L′=(n′ᵢ) [i=1, 2 . . . , lₘₐₓ] as the binary Huffman code distribution L=(nᵢ) [i=1, 2 . . . , lₘₐₓ], nᵢ being the number of codewords of length i, and constructed by implementation of the following steps:
(a) creating a synchronization tree structure of the code with decreasing depths for each elementary branch of said tree, with initialized parameters D=lₘₐₓ, K=nₗₘₐₓ/2, and current l=l_{cur}=lₘₐₓ, the notations being:
   D=arbitrary integer representing the maximum length of a string of zeros;
   lₘₐₓ=the greatest codeword length;
   K=arbitrary integer representing the maximum length of a string of ones;
   nₗₘₐₓ=number of codewords of length lₘₐₓ in the Huffman code;
(b) for each length l_{cur} beginning from lₘₐₓ, if n′_{lcur}≠n_{lcur}, using the codeword 1ₖ as prefix and anchor to it the maximal size elementary branch of depth D′=l_{cur}−K;
(c) if 1ₖ cannot be used as prefix, find a suitable prefix by choosing the minimal length codeword that is in excess with respect to the desired distribution.

It is another object of the invention to propose a method of encoding digital signals incorporating said processing method.

To this end, the invention relates to a method of encoding digital signals comprising at least the steps of applying to said digital signal an orthogonal transformation producing a plurality of coefficients, quantizing said coefficients and coding the quantized coefficients by means of a variable length coding step in which the more frequently occurring values are represented by shorter code lengths and the less frequently occurring values by longer code lengths, said variable length coding step including a defining sub-step for generating a set of codewords corresponding to said digital signals and in which the code used is built with the same length distribution L′=(n′ᵢ) [i=1, 2 . . . , lₘₐₓ] as the binary Huffman code distribution L=(nᵢ) [i=1, 2 . . . , lₘₐₓ], nᵢ being the number of codewords of length i, and is constructed by implementation of the following steps:
(a) creating a synchronization tree structure of the code with decreasing depths for each elementary branch of said tree, with initialized parameters D=lₘₐₓ, K=nₗₘₐₓ/2 and current l=l_{cur}=lₘₐₓ, the notations being:
   D=arbitrary integer representing the maximum length of a string of zeros;
   lₘₐₓ=the greatest codeword length;
   K=arbitrary integer representing the maximum length of a string of ones;
   nₗₘₐₓ=number of codewords of length lₘₐₓ in the Huffman code;
(b) for each length called l_{cur} beginning from lₘₐₓ, if n′_{lcur}≠n_{lcur}, using the codeword 1ₖ as prefix and anchor to it the maximal size elementary branch of depth D′=l_{cur}−K;
(c) if 1ₖ cannot be used as prefix, find a suitable prefix by choosing the minimal length codeword that is in excess with respect to the desired distribution.

It is still another object of the invention to propose an encoding device corresponding to said encoding method.

To this end, the invention relates to a device for encoding digital signals, said device comprising at least an orthogonal transform module, applied to said input digital signals for producing a plurality of coefficients, a quantizer, coupled to said transform module for quantizing said plurality of coefficients and a variable length coder, coupled to said quantizer for coding said plurality of quantized coefficients in accordance with a variable length coding algorithm and generating an encoded stream of data bits, said coefficient coding operation, in which the more frequently occurring values are represented by shorter code lengths and the less frequently occurring values by longer code lengths, including a defining sub-step for generating a set of codewords corresponding to said digital signals and in which the code used is built with the same length distribution L′=(n′ᵢ) [i=1, 2 . . . , lₘₐₓ] as the binary Huffman code distribution L=(nᵢ) [i=1, 2 . . . , lₘₐₓ], nᵢ being the number of codewords of length i, and is constructed by implementation of the following steps:
(a) creating a synchronization tree structure of the code with decreasing depths for each elementary branch of said tree, with initialized parameters D=lₘₐₓ, K=nₗₘₐₓ/2, and current l=l_{cur}=lₘₐₓ, the notations being:
   D=arbitrary integer representing the maximum length of a string of zeros;
   lₘₐₓ=the greatest codeword length;
   K=arbitrary integer representing the maximum length of a string of ones;
   nₗₘₐₓ=number of codewords of length lₘₐₓ in the Huffman code;
(b) for each length l_{cur} beginning from lₘₐₓ, if n′_{lcur}≠n_{lcur}, using the codeword 1ₖ as prefix and anchor to it the maximal size elementary branch of depth D′=l_{cur}−K;
(c) if 1ₖ cannot be used as prefix, find a suitable prefix by choosing the minimal length codeword that is in excess with respect to the desired distribution.

The proposed principle for a new, generic variable length code tree structure, which keeps the optimal distance distribution of the Huffman code while also offering a noticeable improvement of the error span, performs as well as the solution proposed in the cited document, but for a much smaller complexity, which allows to apply the algorithm according to the invention to both short and longer codes, as for example the code used in the H.263 video coders.

### BRIEF DESCRIPTION OF THE DRAWINGS

The invention will now be described in a more detailed manner, with reference to the accompanying drawings in which:

FIG. 1 shows an example of tree structure of a fast synchronizing code;

FIG. 2 gives a flowchart of a synchronization optimization algorithm according to the invention;

FIG. 3 is a table illustrating the comparison between the solution according to the invention and the prior art.

### DETAILED DESCRIPTION

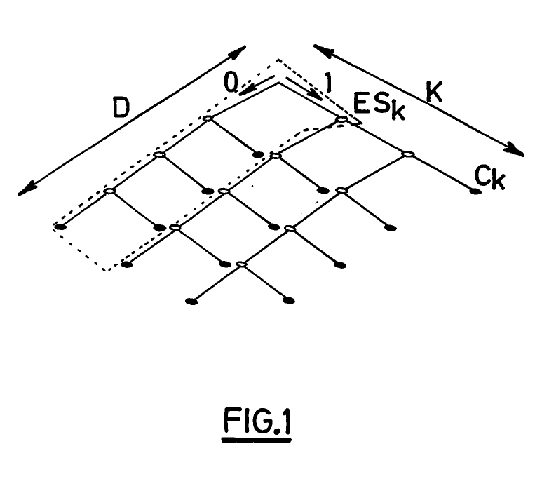

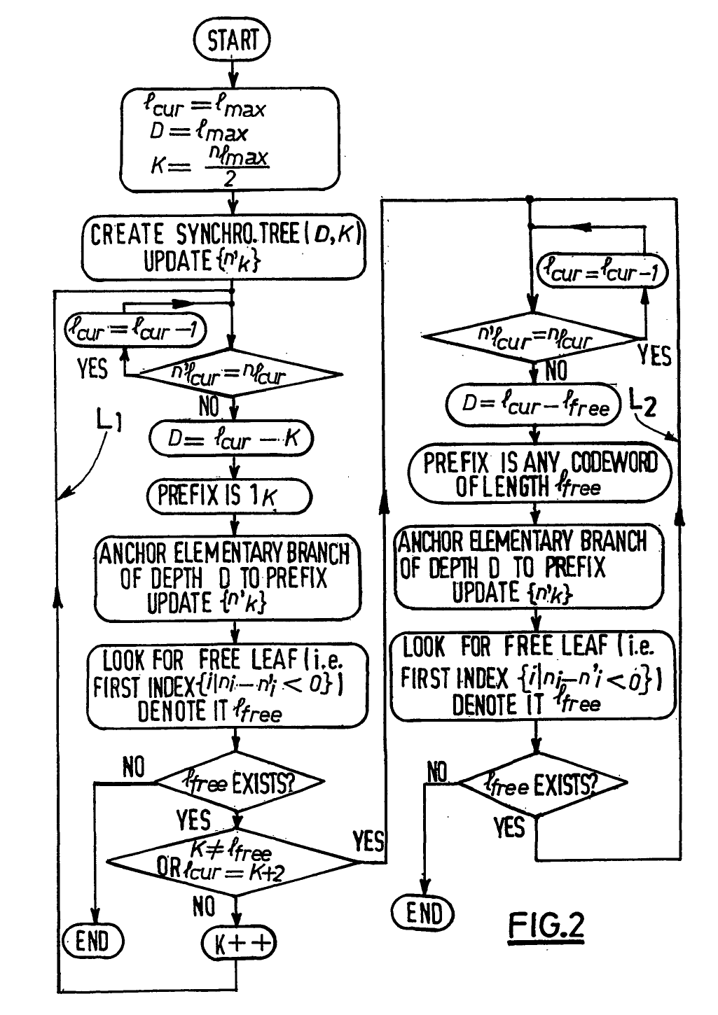

Since the limitations indicated hereinabove for the structure according to the prior art, for the family F of variable length codes, come from the fact that the codes are the repetition of K elementary branches of same depth D (illustrated in dashed line in FIG. 1), the main idea of the invention is to build codes where the different branch sizes may vary. Let L=(nᵢ)_{i=1, 2, . . . , l}_{ₘₐₓ} be the binary Huffman code length distribution, with nᵢ designating the corresponding number of codewords of length i and lₘₐₓ the greatest codeword length, and (by construction) nlₘₐₓ being even. The algorithm given in the flowchart of FIG. 2 then produces a code with a length distribution L′=(n′ᵢ)_{i=1, 2 . . . , l}_{ₘₐₓ} which is identical to L after implementation of the following main steps:
creating a synchronization tree with decreasing depths for each elementary branch (originally, with initialized parameters D=lₘₐₓ, K=nₗₘₐₓ/2, and current l=l_{cur}=lₘₐₓ) in order to ensure that n′ₗₘₐₓ=nₗₘₐₓ (upper part of FIG. 2);
for each length l_{cur} beginning from lₘₐₓ and if n′_{lcur}≠n_{lcur}, using the codeword 1ₖ as prefix and anchoring to said codeword the maximal size elementary branch of depth D′=l_{cur}−K (in FIG. 2, left loop L1);
if 1ₖ cannot be used as prefix (either because l_{cur} is too small or because using 1ₖ would irreparably deplete the current length distribution), finding a suitable prefix by choosing the minimal length codeword that is in excess with respect to the desired distribution (in FIG. 2, right loop L₂, in which l_{free} designates, as indicated in FIG. 2, the first index {i|nₗ−n′ₗ|<0} previously defined within the loop L1).

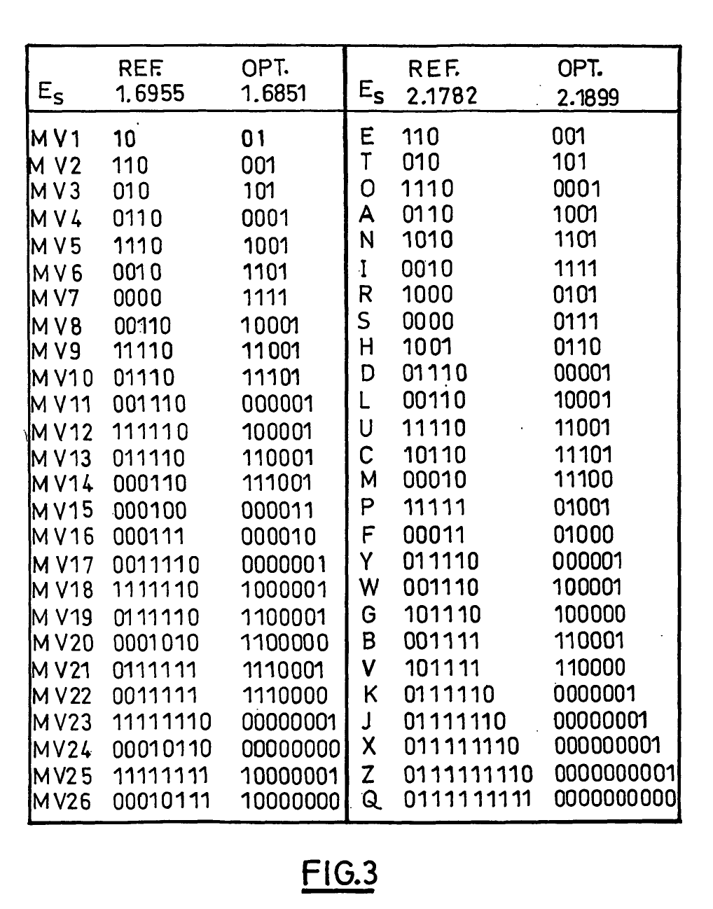

The invention also relates to a method of encoding digital signals that incorporates a processing method as described above for reducing the amount of data representing input digital signals, said method allowing to generate by means of a variable length coding step a set of codewords such that the more frequently occurring values of digital signals are represented by shorter code lengths and the less frequently occurring values by longer code lengths, said variable length coding step including a defining sub-step for generating said set of codewords and in which the code used is built with the same length distribution L′=(n′ᵢ) [i=1, 2 . . . , lₘₐₓ] as the binary Huffman code distribution L=(nᵢ) [i=1, 2 . . . , lₘₐₓ], nᵢ being the number of codewords of length i, and is constructed by implementation of the following steps:
(a) creating a synchronization tree structure of the code with decreasing depths for each elementary branch of said tree, with initialized parameters D=lₘₐₓ, K=nₗₘₐₓ/2, and current l=l_{cur}=lₘₐₓ, the notations being:
   D=arbitrary integer representing the maximum length of a string of zeros;
   lₘₐₓ=the greatest codeword length;
   K=arbitrary integer representing the maximum length of a string of ones;
   nₗₘₐₓ=number of codewords of length lₘₐₓ in the Huffman code;
(b) for each length l_{cur} beginning from lₘₐₓ, if n′_{lcur}≠n_{lcur}, using the codeword 1ₖ as prefix and anchor to it the maximal size elementary branch of depth D′=l_{cur}−K;
(c) if 1ₖ cannot be used as prefix, find a suitable prefix by choosing the minimal length codeword that is in excess with respect to the desired distribution. The invention also relates to the corresponding encoding device. The results obtained when implementing said invention are presented in FIG. 3 for two reference codes as proposed in the document “Error states and synchronization recovery for variable length codes”, by Y. Takishima and al., IEEE Transactions on Communications, vol. 42, No. 2/3/4, February March/April 1994, pp. 783-792, i.e. a code for motion vectors (table VIII of said document) and the English alphabet. As it can be seen in the table of FIG. 3, where it appears that the values of Eₛ are very close to each other in both situations, the proposed codes perform as well as those obtained in said document, but are obtained for a much smaller complexity since the algorithm according to the invention allows to obtain a limited number of iterations (with respect to said document, in which the described algorithm undertakes manipulations on a greater number of branches).

The proposed algorithm is even so simple that it can be applied by hand for relatively short codes, where the fast synchronizing structure is obtained in only three iterations (of the algorithm), or also to longer codes, as for example the 206-symbols variable length code used in an H.263 video codec to encode the DCT coefficients, for which the error span is, when using the invention, much smaller than the original one for the same average length (which means that the decoder would statistically resynchronize one symbol before the current case with the code according to the present invention, and at no cost in terms of coding rate).

1. A method of processing digital signals for reducing the amount of data used to represent said digital signals and forming by means of a variable length coding step a set of codewords such that the more frequently occurring values of digital signals are represented by shorter code lengths and the less frequently occurring values by longer code lengths, said variable length coding step including a defining sub-step for generating said set of codewords and in which the code used is built with the same length distribution L′=(n′ᵢ) [i=1, 2 . . . , lₘₐₓ] as the binary Huffman code distribution L=(nᵢ) [i=1, 2 . . . , lₘₐₓ], nᵢ being the number of codewords of length i, and is constructed by implementation of the following steps:
(a) creating a synchronization tree structure of the code with decreasing depths for each elementary branch of said tree, with initialized parameters D=lₘₐₓ, K=nₗₘₐₓ/2, and current l=l_{cur}=lₘₐₓ, the notations being:
D=arbitrary integer representing the maximum length of a string of zeros;
lₘₐₓ=the greatest codeword length;
K=arbitrary integer representing the maximum length of a string of ones;
nₗₘₐₓ=number of codewords of length lₘₐₓ in the Huffman code;
(b) for each length l_{cur} beginning from lₘₐₓ, if n′_{lcur}≠n_{lcur}, using the codeword 1ₖ as prefix and anchor to it the maximal size elementary branch of depth D′=l_{cur}−K;
(c) if 1ₖ cannot be used as prefix, find a suitable prefix by choosing the minimal length codeword that is in excess with respect to the desired distribution.

2. A method of encoding digital signals comprising at least the steps of applying to said digital signal an orthogonal transform producing a plurality of coefficients, quantizing said coefficients and coding the quantized coefficients by means of a variable length coding step in which the more frequently occurring values are represented by shorter code lengths and the less frequently occurring values by longer code lengths, said variable length coding step including a defining sub-step for generating a set of codewords corresponding to said digital signals and in which the code used is built with the same length distribution L′=(n′ᵢ) [i=1, 2 . . . , lₘₐₓ] as the binary Huffman code distribution L=(nᵢ) [i=1, 2 . . . , lₘₐₓ], nᵢ being the number of codewords of length i, and is constructed by implementation of the following steps:
(a) creating a synchronization tree structure of the code with decreasing depths for each elementary branch of said tree, with initialized parameters D=lₘₐₓ, K=nₗₘₐₓ/2 and current l=l_{cur}=lₘₐₓ, the notations being:
D=arbitrary integer representing the maximum length of a string of zeros;
lₘₐₓ=the greatest codeword length;
K=arbitrary integer representing the maximum length of a string of ones;
nₗₘₐₓ=number of codewords of length lₘₐₓ in the Huffman code;
(b) for each length called l_{cur} beginning from lₘₐₓ, if n′_{lcur}≠n_{lcur}, using the codeword 1ₖ as prefix and anchor to it the maximal size elementary branch of depth D′=l_{cur}−K;
(c) if 1ₖ cannot be used as prefix, find a suitable prefix by choosing the minimal length codeword that is in excess with respect to the desired distribution.

3. A device for encoding digital signals, said device comprising at least an orthogonal transform module, applied to said input digital signals for producing a plurality of coefficients, a quantizer, coupled to said transform module for quantizing said plurality of coefficients and a variable length coder, coupled to said quantizer for coding said plurality of quantized coefficients in accordance with a variable length coding algorithm and generating an encoded stream of data bits, said coefficient coding operation, in which the more frequently occurring values are represented by shorter code lengths and the less frequently occurring values by longer code lengths, including a defining sub-step for generating a set of codewords corresponding to said digital signals and in which the code used is built with the same length distribution L′=(n′ᵢ) [i=1, 2 . . . , lₘₐₓ] as the binary Huffman code distribution L=(nᵢ) [i=1, 2 . . . , lₘₐₓ], nᵢ being the number of codewords of length i, and is constructed by implementation of the following steps:
(a) creating a synchronization tree structure of the code with decreasing depths for each elementary branch of said tree, with initialized parameters D=lₘₐₓ, K=nₗₘₐₓ/2, and current l=l_{cur}=lₘₐₓ, the notations being:
D=arbitrary integer representing the maximum length of a string of zeros;
lₘₐₓ=the greatest codeword length;
K=arbitrary integer representing the maximum length of a string of ones;
nₗₘₐₓ=number of codewords of length lₘₐₓ in the Huffman code;
(b) for each length l_{cur} beginning from lₘₐₓ, if n′_{lcur}≠n_{lcur}, using the codeword 1ₖ as prefix and anchor to it the maximal size elementary branch of depth D′=l_{cur}−K;
(c) if 1ₖ cannot be used as prefix, find a suitable prefix by choosing the minimal length codeword that is in excess with respect to the desired distribution.
